(19) United States
(12) Patent Application Publication
(10) Pub. No.: US 2024/0376233 A1
(43) Pub. Date: Nov. 14, 2024

(54) FLUORORESIN, MANUFACTURING METHOD THEREFOR, COMPOSITION, AND ARTICLE

(71) Applicant: AGC Inc., Tokyo (JP)

(72) Inventors: Fumiko NAKAYAMA, Tokyo (JP); Yukiko SHIOTA, Tokyo (JP)

(73) Assignee: AGC Inc., Tokyo (JP)

(21) Appl. No.: 18/765,413

(22) Filed: Jul. 8, 2024

Related U.S. Application Data
(63) Continuation of application No. PCT/JP2023/002247, filed on Jan. 25, 2023.

(30) Foreign Application Priority Data
Feb. 21, 2022 (JP) 2022-024717

(51) Int. Cl. C08F 8/32

(52) U.S. Cl. CPC C08F 8/32; C08F 2810/40

(57) ABSTRACT

A fluororesin having excellent storage stability with a solvent and adhesion to a base material; a method of its production; a composition including the fluororesin and a solvent; and an article including the composition. The fluororesin includes a polymer having a fluorine-containing aliphatic ring structure within a main chain comprising at least one of an alkoxycarbonyl group having an alkoxy group of 1 to 3 carbon atoms and an amide group having a coupling group. An IR spectrum of a 200 μm thick cast film of the fluororesin satisfies 0.010≤B/A≤0.7 where A is a local maximum absorbance at 1,780 to 1,800 cm⁻¹, measured from a straight line connecting an absorbance at 1,700 cm⁻¹ and an absorbance at 1,925 cm⁻¹, and B is an absorbance at 1,720 cm⁻¹, measured from a straight line connecting an absorbance at 1,647 cm⁻¹ and an absorbance at 1,763 cm⁻¹.

This application is a continuation application of International Application No. PCT/JP2023/002247, filed on Jan. 25, 2023, which claims priority to Japanese Patent Application No. 2022-024717, filed on Feb. 21, 2022, the entire contents of which are incorporated herein by reference.

### TECHNICAL FIELD

The present invention relates to a fluororesin, a method for producing the same, a composition, and an article.

### BACKGROUND ART

Fluororesins have excellent low surface energy, insulation properties, chemical resistance, and the like. In particular, since fluorine-containing polymers having fluorine-containing aliphatic ring structures within the main chains thereof not only have the above-mentioned characteristics but also being amorphous, they exhibit little absorption from ultraviolet rays to near-infrared rays and exhibit excellent transparency. Fluorine-containing polymers having a fluorine-containing aliphatic ring structure within the main chain are also suitable for coating because they can be dissolved in solvents, and are used for various applications.

Patent Document 1 describes that a solution of a fluorine-containing polymer having a fluorine-containing aliphatic ring structure within the main chain and having a coupling group is used for coating applications.

At the main chain end of a fluorine-containing polymer obtained by polymerizing a monomer using a polymerization initiator or the like, an unstable group derived from the monomer, polymerization initiator, chain transfer agent, or the like is present. This unstable group may impair the excellent characteristics of the fluororesin or cause changes over time. Accordingly, Patent Document 2 proposes a method of stabilizing the unstable group by converting it into a carboxylic acid fluoride group. Further, Patent Document 2 describes that the carboxylic acid fluoride group is further converted into a methyl ester group, and various functional groups exhibiting adhesion to the base material can be introduced into the end of the fluororesin from the methyl ester group through an ester exchange reaction or the like.

### CITATION LIST

### Patent Documents

[Patent Document 1] Japanese Unexamined Patent Application, First Publication No. JP. H04-226177

### [Patent Document 2] International Patent Publication No. 2014/156996

### SUMMARY OF INVENTION

### Technical Problem

However, with the techniques described in Patent Documents 1 and 2, it is difficult to achieve both high levels of storage stability under the coexistence of a solvent and adhesion to the base material.

The present invention provides: a fluororesin that exhibits excellent storage stability under the coexistence of a solvent and adhesion to a base material; a method for producing the same; a composition excellent in storage stability and capable of forming a coating film that exhibits excellent adhesion to a base material; and an article exhibiting excellent adhesion between a base material and a coating film.

### Solution to Problem

The present invention includes the following aspects.
[1] A fluororesin composed only of a polymer having a fluorine-containing aliphatic ring structure within a main chain, wherein
the polymer comprises at least one of an alkoxycarbonyl group having an alkoxy group of 1 to 3 carbon atoms and an amide group having a coupling group, and
a cast film composed of the fluororesin with a thickness of 200 μm satisfies the following Formula 1 in an infrared spectrum measured by a transmission method with a Fourier transform infrared spectrophotometer,

0.010≤B/A≤0.7 Formula 1

In the Formula 1, A indicates a local maximum value of absorbance at a wave number of 1,780 to 1,800 cm⁻¹ due to absorption of the alkoxycarbonyl group, using a straight line connecting an absorbance at a wave number of 1,700 cm⁻¹ and an absorbance at a wave number of 1,925 cm⁻¹ as a baseline, and
B indicates an absorbance value at a wave number of 1,720 cm⁻¹ due to absorption of the amide group, using a straight line connecting an absorbance at a wave number of 1,647 cm⁻¹ and an absorbance at a wave number of 1,763 cm⁻¹ as a baseline.
[2] The fluororesin according to [1] above, which has a mass average molecular weight of 10,000 to 500,000.
[3] The fluororesin according to [1] or [2] above, wherein the polymer comprises a unit having a fluorine-containing aliphatic ring structure constituting a main chain.
[4] The fluororesin according to [3] above, wherein the unit having a fluorine-containing aliphatic ring structure constituting a main chain is at least one selected from the group consisting of a unit formed by cyclopolymerization of a diene-based fluorine-containing monomer, and a unit based on a cyclic fluorine-containing monomer.
[5] The fluororesin according to any one of [1] to [4] above, wherein the coupling group is represented by the following Formula 2.

—SiR¹R²R³ Formula 2

In the Formula 2, each of R¹, R² and R³ independently represents an alkoxy group having 1 to 3 carbon atoms or an alkyl group having 1 to 3 carbon atoms, and
at least one of R¹, R² and R³ is the alkoxy group.
[6] The fluororesin according to any one of [1] to [5] above, wherein the amide group is represented by the following Formula 3.

—CONH—R⁴—SiR¹R²R³ Formula 3

In the Formula 3, each of R¹, R² and R³ independently represents an alkoxy group having 1 to 3 carbon atoms or an alkyl group having 1 to 3 carbon atoms,
at least one of R¹, R² and R³ is the alkoxy group, and
R⁴ is an alkylene group, a group having an imino group between carbon atoms of an alkylene group, or an arylene group.
[7] The fluororesin according to any one of [1] to [6] above, wherein the alkoxycarbonyl group and the amide group are each present at an end of a main chain of the polymer.
[8] A method for producing the fluororesin according to any one of [1] to [7] above,
the method comprising: preparing a first solution by dissolving, in a first solvent, a first fluororesin composed only of a first polymer having a fluorine-containing aliphatic ring structure within a main chain and in which the first polymer comprises the alkoxycarbonyl group;
preparing a second solution by dissolving a compound having a coupling group and an amino group in a second solvent that is compatible with the first solvent; and
mixing the first solution and the second solution and converting 10 to 50% of the alkoxycarbonyl group, calculated as a value of the A, into an amide group by a reaction with the compound.
[9] The production method according to [8] above, wherein in a second fluororesin composed only of a second polymer having a fluorine-containing aliphatic ring structure within a main chain and in which the second polymer comprises an unstable group at an end of the main chain, 50 to 100 mol % of the unstable group is converted into a carboxylic acid fluoride group by heating in the presence of molecular oxygen to obtain a third fluororesin, and
the carboxylic acid fluoride group of the third fluororesin is converted into the alkoxycarbonyl group by a reaction with an alcohol having 1 to 3 carbon atoms to obtain the first fluororesin.
[10] A composition containing the fluororesin according to any one of [1] to [7] above and a solvent.
[11] An article having a coating film of the composition according to above on a base material.

### Advantageous Effects of Invention

The fluororesin of the present invention is excellent in storage stability under the coexistence of a solvent and adhesion to a base material.

According to the method for producing a fluororesin of the present invention, a fluororesin excellent in storage stability under the coexistence of a solvent and adhesion to a base material can be obtained.

The composition of the present invention is excellent in storage stability and can form a coating film that exhibits excellent adhesion to a base material.

The article of the present invention exhibits excellent adhesion between a base material and a coating film.

### BRIEF DESCRIPTION OF DRAWINGS

FIG. 1 is a diagram showing an example of an IR spectrum.

### DESCRIPTION OF EMBODIMENTS

The meanings and definitions of terms are as follows.

The term “aliphatic ring structure” means a saturated or unsaturated ring structure with no aromaticity.

The term “fluorine-containing aliphatic ring structure” means an aliphatic ring structure in which a fluorine atom or a fluorine-containing group is bonded to at least a portion of the carbon atoms constituting the main skeleton of the ring. Examples of the fluorine-containing group include a perfluoroalkyl group, a perfluoroalkoxy group, and ═CF₂. Substituents other than fluorine atoms and fluorine-containing groups may be bonded to the above portion of the carbon atoms constituting the main skeleton of the ring.

An “etheric oxygen atom” is an oxygen atom present between carbon atoms (—C—O—C—).

The term “mass average molecular weight” refers to a polymethyl methacrylate (hereinafter also referred to as “PMMA”) equivalent value measured by gel permeation chromatography (hereinafter also referred to as “GPC”).

In the present specification, a group represented by the Formula 2 is also referred to as a “group 2”, and a compound represented by a Formula ma1 is also referred to as a “compound ma1”. Groups, compounds, and the like represented by other formulae are also described in the same manner.

A symbol “-” indicating a numerical range means that numerical values described before and after this symbol are included as the lower limit value and the upper limit value.

Various numerical ranges disclosed in present specification can be arbitrarily combined with the lower limit values and upper limit values thereof to form a new numerical range.

### (Fluororesin)

A fluororesin according to one embodiment of the present invention (hereinafter also referred to as “the present fluororesin”) is composed only of a polymer having a fluorine-containing aliphatic ring structure within the main chain (hereinafter also referred to as a “polymer A”). Further, the polymer A comprises at least one of an alkoxycarbonyl group having an alkoxy group of 1 to 3 carbon atoms (hereinafter also referred to as an “ester group”) and an amide group having a coupling group. Further, a cast film composed of the present fluororesin with a thickness of 200 μm satisfies the following Formula 1 in an infrared spectrum (hereinafter also referred to as an “IR spectrum”) measured by a transmission method using a Fourier transform infrared spectrophotometer (hereinafter also referred to as “FT-IR”).

0.010≤B/A≤0.7 Formula 1

In the Formula 1, A indicates a local maximum value of the absorbance at a wave number of 1,780 to 1,800 cm⁻¹ due to absorption of the ester group, using a straight line connecting the absorbance at a wave number of 1,700 cm⁻¹ and the absorbance at a wave number of 1,925 cm⁻¹ as a baseline. B indicates an absorbance value at a wave number of 1,720 cm⁻¹ due to absorption of the amide group, using a straight line connecting the absorbance at a wave number of 1,647 cm⁻¹ and the absorbance at a wave number of 1,763 cm⁻¹ as a baseline.

B/A is an indicator of the ratio of the amide group and the ester group in the present fluororesin. When B/A is 0.010 or more, adhesion to the base material is excellent. When B/A is 0.7 or less, storage stability under the coexistence of a solvent is excellent. In the present fluororesin, B/A is preferably from 0.010 to 0.65, more preferably from 0.010 to 0.6, and still more preferably from 0.02 to 0.5. In another example of the present fluororesin, B/A may be from 0.01 to 0.7, from 0.01 to 0.65, from 0.01 to 0.6, or from 0.02 to 0.5.

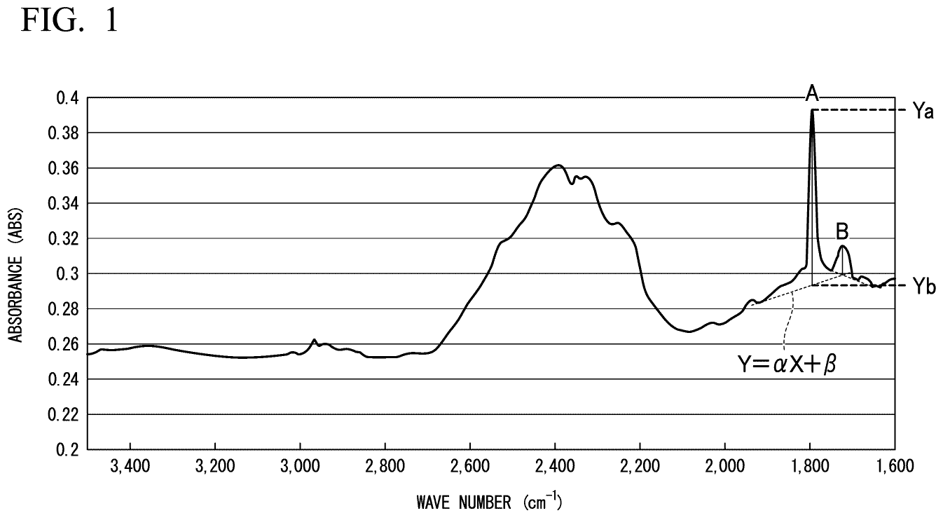

The method for measuring B/A will be described in detail with reference to FIG. 1.

In the measurement of B/A, the value of A is determined by the following procedure using the IR spectrum.

The local maximum value due to the ester group absorption at a wave number of 1,780 to 1,800 cm⁻¹ is defined as Ya, and the wave number of this local maximum value is defined as Xa.

The two baseline points (X=1,700 cm⁻¹, 1,925 cm⁻¹) on the IR spectrum are connected to find a linear function: Y=αx+β. Y denotes absorbance, X denotes wave number, and each of α and β denotes a constant of the linear function.

In the above linear function, the value of Y when X is Xa is found and defined as Yb. The value of Ya−Yb is found and defined as A.

The value of B is found in the same manner as that of A as described above. That is, the value of absorbance at a wave number of 1,720 cm⁻¹ due to the amide group absorption is defined as Yc. The two baseline points (X=1,647 cm⁻¹, 1,763 cm⁻¹) on the IR spectrum are connected to find a linear function: Y=α′X+β′. Y denotes absorbance, X denotes wave number, and each of α′ and β′ denotes a constant of the linear function. In the above function Y=α′X+β′, the value of Y when X is 1,720 is found and defined as Yd. The value of Yc−Yd is found and defined as B.

B/A is calculated from the obtained values of A and B.

FIG. 1 is an example of an IR spectrum shown for explaining the method for measuring B/A, and the IR spectrum of a cast film composed of the present fluororesin with a thickness of 200 μm is not limited thereto. In FIG. 1, the peak near the wave number of 2,400 cm⁻¹ is caused by CF₂.

Typically, the present fluororesin has a B/A ratio within the above numerical range due to mixing of a plurality of polymer A molecules. As used herein, “a plurality of polymer A molecules” means, for example, any two or more of a polymer A molecule having both an ester group and an amide group, a polymer A molecule having an ester group but no amide group, and a polymer A molecule having an amide group but no ester group.

The polymer A itself that can constitute the present fluororesin may have both an ester group and an amide group within one molecule, or may have either one of these, but since the B/A ratio is within the above numerical range, both an ester group and an amide group are present in the present fluororesin.

The alkoxy group in the ester group may be linear or branched. The number of carbon atoms in the alkoxy group is preferably 1 or 2, and particularly preferably 1. Therefore, as the ester group, a methoxycarbonyl group and an ethoxycarbonyl group are preferred, and a methoxycarbonyl group is particularly preferred. The smaller the number of carbon atoms in the alkoxy group within the ester group, the easier the substitution reaction of the ester group to the amide group tends to proceed when producing the polymer A by the production method described later.

The ester group may be present at the end of the main chain of the polymer A, may be present in the side group, or may be present both at the end of the main chain and in the side group. From the viewpoints of adhesion to a base material, storage stability under the coexistence of a solvent, and film-forming properties, it is preferable to be present at the end of the main chain of the polymer A.

One or two or more types of ester groups may be comprised in the present fluororesin.

Examples of the amide group include a group formed by reacting a carboxy group, a salt thereof, or an alkoxycarbonyl group with a compound having a coupling group and an amino group. The compound having a coupling group and an amino group will be explained in detail in a section (method for producing the present fluororesin) described later.

Since the amide group comprises a coupling group, excellent adhesion is exhibited. Examples of the coupling group include a silane coupling group and a phenol group. In view of adhesion, a silane coupling group is preferred.

As the coupling group, the following group 2 is preferred from the viewpoint of better adhesion to a base material.

—SiR¹R²R³ Formula 2

In the Formula 2, each of R¹, R² and R³ independently represents an alkoxy group having 1 to 3 carbon atoms or an alkyl group having 1 to 3 carbon atoms. At least one of R¹, R² and R³ is an alkoxy group.

In R¹, R² and R³, the alkoxy group may be linear or branched. The alkyl group may be linear or branched.

Since at least one of R¹, R², and R³ is an alkoxy group, adhesion to a base material is further improved. Two or three of R¹, R² and R³ are preferably alkoxy groups.

Examples of SiR¹R²R³ include a methyldiethoxysilyl group, a methyldimethoxysilyl group, a trimethoxysilyl group, and a triethoxysilyl group.

Examples of the amide group having the group 2 include the following group 3.

—CONH—R⁴—SiR¹R²R³ Formula 3

In the Formula 3, R¹, R² and R³ are as defined for R¹, R² and R³ in the Formula 2 above, respectively. At least one of R¹, R² and R³ is an alkoxy group. R⁴ is an alkylene group, a group having an imino group between carbon atoms of an alkylene group, or an arylene group.

In R⁴, the alkylene group may be linear or branched. The alkylene group preferably has 1 to 10 carbon atoms, and more preferably has 1 to 4 carbon atoms. In the group having an imino group between the carbon atoms of the alkylene group, the number of carbon atoms in the alkylene group is preferably from 2 to 10, and the number of imino groups is preferably from 1 to 3. The arylene group preferably has 6 to 10 carbon atoms.

Examples of R⁴ include —(CH₂)₃—, —(CH₂)₂NH(CH₂)₃—, and a phenylene group.

The amide group may be present at the end of the main chain of the polymer A, may be present in the side group, or may be present both at the end of the main chain and in the side group. From the viewpoints of adhesion to a base material, storage stability under the coexistence of a solvent, and film-forming properties, it is preferable to be present at the end of the main chain of the polymer A.

One or two or more types of amide groups may be comprised in the present fluororesin.

Since the polymer A has a fluorine-containing aliphatic ring structure within its main chain, it exhibits little absorption from ultraviolet rays to near-infrared rays, exhibits excellent transparency, and can be dissolved in solvents. In addition, the main chain is difficult to decompose, and the weather resistance is excellent.

The fluorine-containing aliphatic ring structure may be a carbocyclic structure in which the ring skeleton is composed only of carbon atoms, or may be a heterocyclic structure in which the ring skeleton comprises an atom (hetero atom) other than carbon atoms. Examples of the hetero atom include an oxygen atom and a nitrogen atom. The number of atoms constituting the ring skeleton of the fluorine-containing aliphatic ring structure is preferably from 4 to 7, and particularly preferably from 5 to 6. That is, the aliphatic ring structure is preferably a 4- to 7-membered ring, and particularly preferably a 5- to 6-membered ring.

From the viewpoints of transparency and solvent solubility, the fluorine-containing aliphatic ring structure is preferably a fluorine-containing aliphatic ring structure having a heterocyclic structure with an etheric oxygen atom in the ring skeleton, and particularly preferably a fluorine-containing aliphatic ring structure having a heterocyclic structure with one or two etheric oxygen atoms in the ring skeleton.

Examples of the fluorine-containing aliphatic ring structure include a ring structure in which some or all of the hydrogen atoms in a hydrocarbon ring structure or a heterocyclic structure are substituted with fluorine atoms.

Among these, a fluorine-containing aliphatic ring structure in which some or all of the hydrogen atoms in a heterocyclic structure having an etheric oxygen atom in the ring skeleton are substituted with fluorine atoms is preferred, and a fluorine-containing aliphatic ring structure in which some or all of the hydrogen atoms in a heterocyclic structure having one or two etheric oxygen atoms in the ring skeleton are substituted with fluorine atoms is particularly preferred.

As the fluorine-containing aliphatic ring structure, a perfluoroaliphatic ring structure in which all of the hydrogen atoms in a hydrocarbon ring structure or a heterocyclic structure are substituted with fluorine atoms is preferred.

As the polymer A, a polymer having the following unit a1 is preferred.

The polymer A may further have a unit other than the unit a1 (hereinafter also referred to as a “unit a2”) as necessary.

The unit a1 is a unit having a fluorine-containing aliphatic ring structure. The fluorine-containing aliphatic ring structure in the unit a1 constitutes the main chain of the polymer A. The unit a1 is preferably a perfluoro unit.

The above description in which the fluorine-containing aliphatic ring structure “constitutes the main chain” means that at least one of the carbon atoms constituting the ring skeleton of the fluorine-containing aliphatic ring structure is a carbon atom constituting the main chain of the polymer. In other words, it means that since two carbon atoms derived from a polymerizable double bond constitute the main chain of the polymer, one or two adjacent carbon atoms constituting the ring of the fluorine-containing aliphatic ring structure are carbon atoms derived from one polymerizable double bond.

For example, when the unit a1 is formed by addition polymerization of monoene-based monomers, either two carbon atoms derived from the polymerizable double bond constitute the main chain and these two carbon atoms are two adjacent carbon atoms in the ring skeleton, or one of the two carbon atoms is a carbon atom in the ring skeleton. In addition, when the unit a1 is formed by cyclopolymerization of a diene-based monomer, a total of four carbon atoms derived from two polymerizable double bonds constitute the main chain, and two to four of these four carbon atoms are the carbon atoms constituting the ring skeleton.

Examples of the unit a1 include a unit formed by cyclopolymerization of a diene-based fluorine-containing monomer, and a unit based on a cyclic fluorine-containing monomer.

A diene-based fluorine-containing monomer is a monomer having two polymerizable double bonds and a fluorine atom. In the case of a diene-based fluorine-containing monomer, the unit a1 is formed by cyclopolymerization. The polymerizable double bond is not particularly limited, but is preferably a vinyl group, an allyl group, an acryloyl group, or a methacryloyl group. In these polymerizable double bonds, some or all of the hydrogen atoms bonded to carbon atoms may be replaced with fluorine atoms.

As the diene-based fluorine-containing monomer, the following compound ma1 is preferred.

CF₂═CF-Q-CF—CF₂ Formula ma1

In the Formula ma1, Q is a perfluoroalkylene group having 1 to 6 carbon atoms which may have some of the fluorine atoms substituted with halogen atoms other than fluorine atoms and may have an etheric oxygen atom.

In the Formula ma1, the number of carbon atoms in the perfluoroalkylene group represented by Q is from 1 to 6, preferably from 1 to 5, and particularly preferably from 1 to 3. The perfluoroalkylene group is preferably linear or branched, and particularly preferably linear.

In the perfluoroalkylene group, some of the fluorine atoms may be substituted with halogen atoms other than fluorine atoms. Examples of the halogen atoms other than fluorine atoms include chlorine atoms and bromine atoms.

The perfluoroalkylene group may have an etheric oxygen atom.

Q is preferably a perfluoroalkylene group having an etheric oxygen atom. In that case, the etheric oxygen atom in the perfluoroalkylene group may be present at one end of the perfluoroalkylene group, may be present at both ends of the perfluoroalkylene group, or may be present between carbon atoms of the perfluoroalkylene group. From the viewpoint of cyclopolymerizability, it is preferable to be present at one end of the perfluoroalkylene group.

As Q, the following groups q1 and q2 are preferred.

—(CR¹¹R¹²)ₕ— Formula q1

—(CR¹³R¹⁴)ᵢO(CR¹⁵R¹⁶)ⱼ— Formula q2

In each formula, each of R¹¹, R¹², R¹³, R¹⁴, R¹⁵ and R¹⁶ independently represents a fluorine atom, a chlorine atom, a trifluoromethyl group or a trifluoromethoxy group. h is an integer from 2 to 4, and a plurality of R¹¹ and R¹² groups may be the same as or different from each other. Each of i and j is an integer from 0 to 3, and i+j is an integer from 1 to 3. When i is 2 or 3, a plurality of R¹³ and R¹⁴ groups may be the same as or different from each other. When j is 2 or 3, a plurality of R¹⁵ and R¹⁶ groups may be the same as or different from each other.
h is preferably 2 or 3. It is preferable that R¹¹ and R¹² are a11 fluorine atoms, or all but one or two are fluorine atoms. It is preferable that i is 0 and j is 1 or 2. It is preferable that R¹⁵ and R¹⁶ are all fluorine atoms, or all but one or two are fluorine atoms.

Examples of the compound ma1 include the following compounds.
CF₂═CFOCF₂CF═CF₂,
CF₂═CFOCF(CF₃)CF═CF₂,
CF₂═CFOCF₂CF₂CF═CF₂,
CF₂═CFOCF₂CF(CF₃)CF═CF₂,
CF₂═CFOCF(CF₃)CF₂CF═CF₂,
CF₂═CFOCFClCF₂CF═CF₂,
CF₂═CFOCCl₂CF₂CF═CF₂,
CF₂═CFOCF₂OCF═CF₂,
CF₂═CFOC(CF₃)₂OCF═CF₂,
CF₂═CFOCF₂CF(OCF₃)CF═CF₂,
CF₂═CFCF₂CF═CF₂,
CF₂═CFCF₂CF₂CF═CF₂,
CF₂═CFCF₂OCF₂CF═CF₂.

Examples of the cyclic fluorine-containing monomer include a monomer containing a fluorine-containing aliphatic ring and having a polymerizable double bond between carbon atoms constituting the fluorine-containing aliphatic ring, and a monomer containing a fluorine-containing aliphatic ring and having a polymerizable double bond between a carbon atom constituting the fluorine-containing aliphatic ring and a carbon atom outside the fluorine-containing aliphatic ring.

As the cyclic fluorine-containing monomer, the following compounds ma2 and compound ma3 are preferred.

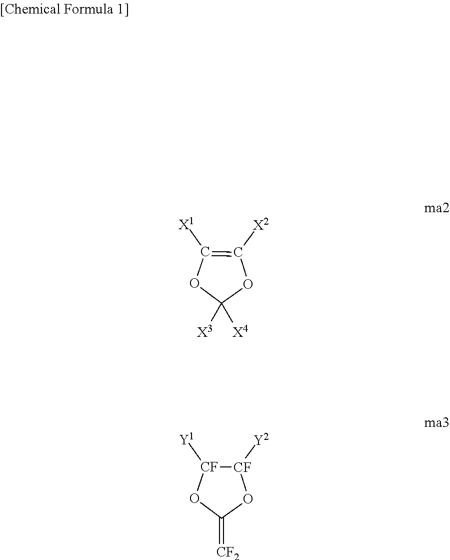

In each formula, each of X¹, X², X³, X⁴, Y¹ and Y² independently represents a fluorine atom, a perfluoroalkyl group which may have an etheric oxygen atom, or a perfluoroalkoxy group which may have an etheric oxygen atom. X³ and X⁴ may be bonded to each other to form a ring.

In the Formulae ma2 and ma3, the number of carbon atoms in the perfluoroalkyl group represented by X¹, X², X³, X⁴, Y¹ and Y² is preferably from 1 to 7, more preferably from 1 to 5, and particularly preferably from 1 to 4. The perfluoroalkyl group is preferably linear or branched, and particularly preferably linear. As the perfluoroalkyl group, a trifluoromethyl group, a pentafluoroethyl group, a heptafluoropropyl group, and the like are preferred, and a trifluoromethyl group is particularly preferred.

Examples of the perfluoroalkoxy group represented by X¹, X², X³, X⁴, Y¹ and Y² include those in which an oxygen atom (—O—) is bonded to the perfluoroalkyl group described above. A trifluoromethoxy group is particularly preferred.

When the number of carbon atoms in the above perfluoroalkyl group and the above perfluoroalkoxy group is 2 or more, an etheric oxygen atom (—O—) may be present between the carbon atoms of the perfluoroalkyl group or between the carbon atoms of the perfluoroalkoxy group.

In the Formula ma2, X¹ is preferably a fluorine atom.

X² is preferably a fluorine atom, a trifluoromethyl group, or a perfluoroalkoxy group having 1 to 4 carbon atoms, and particularly preferably a fluorine atom or a trifluoromethoxy group.

Each of X³ and X⁴ independently preferably represents a fluorine atom or a perfluoroalkyl group having 1 to 4 carbon atoms, and particularly preferably represents a fluorine atom or a trifluoromethyl group.

X³ and X⁴ may be bonded to each other to form a ring. The number of atoms constituting the ring skeleton of the above ring is preferably from 4 to 7, and more preferably from 5 to 6.

In the Formula ma3, each of Y¹ and Y² independently preferably represents a fluorine atom, a perfluoroalkyl group having 1 to 4 carbon atoms, or a perfluoroalkoxy group having 1 to 4 carbon atoms, and particularly preferably represents a fluorine atom or a trifluoromethyl group.

Preferred examples of the compound ma2 include the following compounds ma21 to ma25.

Preferred examples of the compound ma3 include the following compounds ma31 and ma32.

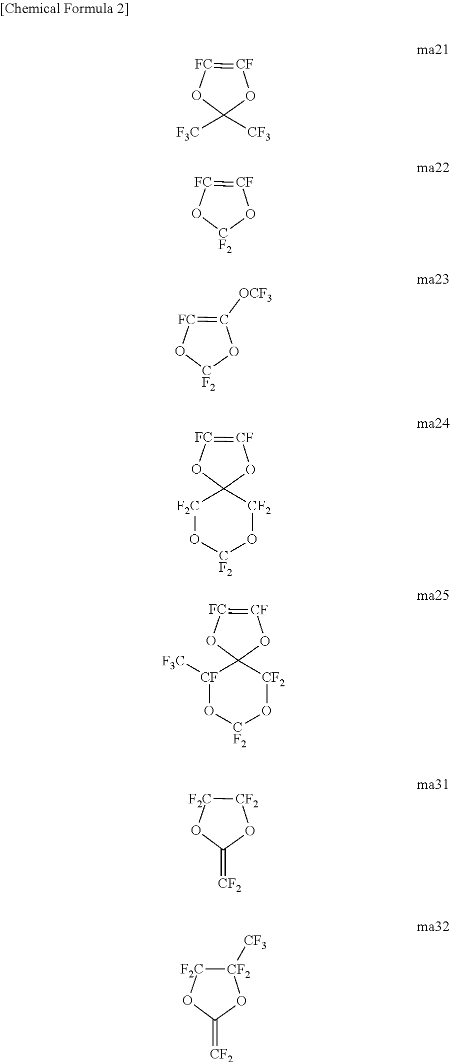

The unit a1 is preferably at least one selected from the group consisting of the following units a11 to a16.

The units a11 to a14 are units formed by cyclopolymerization of the compound ma1, and at least one of the units a11 to a14 is produced by cyclopolymerization of the compound ma1. At this time, units having a structure in which the number of atoms constituting the ring skeleton of the fluorine-containing aliphatic ring is 5 or 6 are likely to be produced among the units a11 to a14. Polymers containing two or more of these units may also be produced.

In other words, the compound ma1 is preferably a compound ma1 having a structure in which the number of atoms constituting the ring skeleton including the atoms in Q is 5 or 6 in the following units a11 to a14.

The following unit a15 is a unit formed from the compound ma2, and the following unit a16 is a unit formed from the compound ma3.

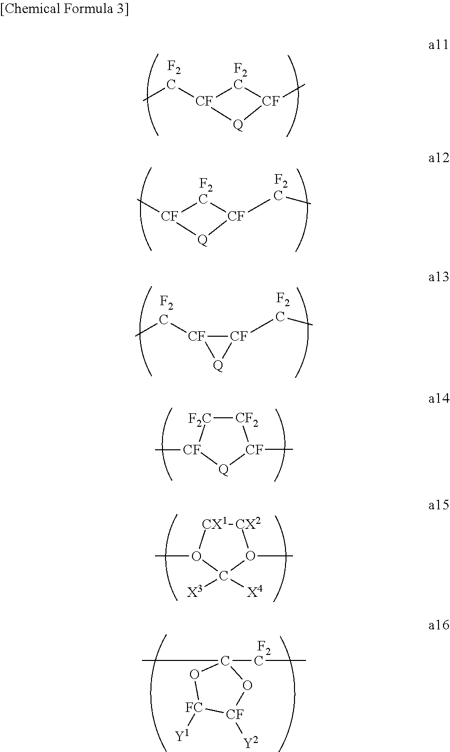

As the unit a1, a unit formed by cyclopolymerization of a diene-based fluorine-containing polymer is preferred from the viewpoint of excellent chemical stability.

One or two or more types of the units a1 may be included in the polymer A.

The unit a2 is another unit other than the unit a1.

The unit a2 is not particularly limited as long as it is based on a monomer that can be copolymerized with the monomer forming the unit a1. Examples thereof include a unit based on a monomer having a reactive functional group and a polymerizable double bond (hereinafter also referred to as a “unit a21”), a unit based on a fluorine-containing olefin such as tetrafluoroethylene, and a unit based on a fluorine-containing vinyl ether. One or two or more types of the units a2 may be included in the polymer A.

Regarding the unit a21, examples of the polymerizable double bond include CF₂═CF—, CF₂═CH—, CH₂—CF—, CFH═CF—, CFH═CH—, CF₂—C—, and CF═CF—.

The term “reactive functional group” means a reactive group that can form a chemical bond (such as a hydrogen bond and a covalent bond) by a reaction, between molecules of a polymer having a reactive functional group, or with other substances (such as metals and alloys) other than the above polymer when drying or the like. Examples of the reactive functional group include a carboxy group, an acid halide group, an alkoxycarbonyl group, a carbonyloxy group, a carbonate group, a sulfo group, a phosphono group, a hydroxy group, a thiol group, a silanol group, and a coupling group. The unit a21 may have an ester group or an amide group.

The unit a2 is preferably a perfluoro unit, with the exception of the unit a21. In the case of the unit a21, except for the reactive functional group moiety, it is preferable not to have a hydrogen atom bonded to a carbon atom.

As an example of the unit a21, the following unit a21-1 can be mentioned. The unit a21-1 can be formed by polymerization of CF₂═CF—O—R^{f}—X.

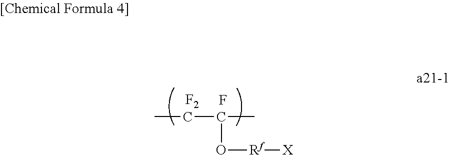

In the formula a21-1, R^{f} is a perfluoroalkylene group which may have an etheric oxygen atom, X is COOH, COOR, SO₂F, SO₃R, or SO₃H, and R is an alkyl group having 1 to 5 carbon atoms.

In the formula a21-1, the perfluoroalkylene group represented by R^{f} is preferably linear or branched. The number of carbon atoms in the perfluoroalkylene group is preferably from 2 to 10, more preferably from 2 to 7, and particularly preferably from 2 to 5.

The perfluoroalkylene group may have an etheric oxygen atom. In this case, the number of etheric oxygen atoms in the perfluoroalkylene group may be one or two or more.

Examples of R^{f} include the following.
CF₂CF₂CF₂—,
—CF₂CF(CF₃) OCF₂CF₂—,
—CF₂CF₂CF(CF₃) OCF₂CF₂—,
—CF₂CF(CF₃) OCF₂CF₂CF₂—.

The alkyl group represented by R in COOR and SO₃R is preferably linear or branched. The alkyl group is preferably an alkyl group having 1 to 6 carbon atoms, and particularly preferably a methyl group.

As X, COOCH₃, SO₂F, COOH, or SO₃H is preferred.

As the unit a21-1, —O—R^{f}—X in the formula a21-1 is preferably one of the following.
—OCF₂CF(CF₃) OCF₂CF₂COOCH₃,
—OCF₂CF₂CF₂COOCH₃,
—OCF₂CF(CF₃) OCF₂CF₂SO₂F,
—OCF₂CF₂CF₂COOH,
—OCF₂CF(CF₃) OCF₂CF₂CF₂COOCH₃,
—OCF₂CF(CF₃) OCF₂CF₂SO₃H.

The content of the unit a1 in the present fluororesin is preferably 30 mol % or more, more preferably 50 mol % or more, still more preferably 70 mol % or more, and may be 100 mol %, with respect to the total of all units constituting the present fluororesin. When the content of the unit a1 is equal to or higher than the above lower limit value, transparency and solubility in solvents are further improved.

The present fluororesin preferably has an unstable group content of 5 ppm or less, and is particularly preferably free of unstable groups. Unstable groups decompose when the polymer is molded or used at high temperatures, and may therefore cause corrosion of the device and coloration of the fluororesin itself. When the content of unstable groups is 5 ppm or less, corrosion of the device and coloration of the fluororesin can be suppressed.

The content of unstable groups is measured by 1H-NMR. More specifically, it is determined by the following method.

A fluororesin and p-hexafluoroxylene as a standard substance are dissolved in perfluorobenzene at a ratio of 100:1 (mass ratio) to prepare a sample for measurement. The concentration (mol/g) of each unstable group in the fluororesin is determined from the ratio of the area of the peak derived from p-hexafluoroxylene and the area of the peak derived from each unstable group, and the sum thereof is taken as the content of unstable groups. Regarding the peaks derived from each unstable group, for example, the peak derived from CH of isopropyl group is present at around 5 ppm. The peak derived from CH₂ in HO—CH₂— is observed at around 4.3 ppm. The peak derived from H in CF₂H— is observed at around 6.5 ppm. Peaks derived from unstable groups are not limited to these examples.

Examples of the unstable group include residues derived from polymerization initiators, chain transfer agents, dispersion stabilizers, monomers, and the like used when producing a fluororesin by polymerizing monomers. The dispersion stabilizer is a compound used for stabilizing dispersibility when polymerization is carried out by suspension polymerization. In particular, residues derived from at least one selected from the group consisting of polymerization initiators, chain transfer agents, and dispersion stabilizers tend to become unstable groups.

Examples of the unstable group include functional groups having an active hydrogen such as hydroxyl groups, amino groups, carboxy groups, and sulfo groups, groups derived from carboxylic acids such as carboxylic acid halides, carboxylic acid amides, and carboxylic acid esters, carbonate groups, groups derived from sulfonic acids such as sulfonic acid halides, sulfonic acid amides, and sulfonic acid esters, hydrocarbon groups, and hydrogen atoms. Examples thereof include (CH₃)₂CHOC(═O)O— derived from diisopropyl peroxydicarbonate as a polymerization initiator, HO—CH₂— derived from methanol as a chain transfer agent, and hydrogen atoms derived from fluorine-containing monomers.

The mass average molecular weight (Mw) of the present fluororesin is preferably from 10,000 to 500,000, and more preferably from 30,000 to 200,000. When Mw is equal to or more than the above lower limit value, the toughness of the present fluororesin is further improved. When Mw is equal to or less than the above upper limit value, the solubility in solvents and moldability are further improved.

### (Method for Producing the Present Fluororesin)

As the method for producing the present fluororesin, a method comprising: preparing a first solution by dissolving, in a first solvent, a first fluororesin composed only of a first polymer having an aliphatic ring structure within a main chain and in which the first polymer comprises an ester group; preparing a second solution by dissolving a compound having a coupling group and an amino group (hereinafter also referred to as an “amino group-containing compound”) in a second solvent that is compatible with the first solvent; and mixing the first solution and the second solution and converting 10 to 50% of the ester group in the first fluororesin, calculated as a value of A, into an amide group by a reaction with the amino group-containing compound, is preferred.

By using the second solvent, the amino group-containing compound is uniformly dispersed in the first solution. Therefore, the conversion rate of the ester group to an amide group in the first fluororesin can be set to 10 mol % or more. Further, by converting 10 to 50% of the ester group in the first fluororesin into the amide group, the B/A ratio can be set to 0.010 or more and 0.7 or less.

### <First Solution>

The first fluororesin is the same as the present fluororesin with the exception that it does not need to comprise an amide group.

Typically, the first fluororesin does not comprise an amide group.

The first fluororesin is preferably a fluororesin obtained by converting a carboxylic acid fluoride group in the following third fluororesin into an ester group by a reaction with an alcohol having 1 to 3 carbon atoms. The third fluororesin is a fluororesin obtained by converting 50 to 100 mol % of an unstable group, in a second fluororesin composed only of a second polymer having a fluorine-containing aliphatic ring structure within a main chain and in which the second polymer comprises the unstable group at an end of the main chain, into a carboxylic acid fluoride group by heating in the presence of molecular oxygen.

By heating the second fluororesin in the presence of molecular oxygen, the unstable group can be converted to the carboxylic acid fluoride group at a high conversion rate of 50 mol % or more. Therefore, the conversion rate to the ester group also increases. Since the amount of the amide group in the ultimately obtained fluororesin increases, the adhesion to the base material can be further improved.

The second fluororesin is the same as the first fluororesin with the exception that it comprises an unstable group instead of an ester group.

The second fluororesin is typically obtained by polymerizing monomers (for example, a monomer forming the unit a1, and if necessary, a monomer forming the unit a2). The polymerization is preferably carried out in the presence of a polymerization initiator. If necessary, a chain transfer agent, a dispersion stabilizer, and the like may also be present.

The conversion of the unstable group into a carboxylic acid fluoride group can be carried out by the method described in International Patent Publication No. 2014/156996. The amount of molecular oxygen is preferably 50 moles or more and 800 moles or less, and more preferably 500 moles or less, with respect to 1 mole of the unstable group. The heating temperature is preferably 250° C. or higher and 380° C. or lower, and more preferably 350° C. or lower. The heating time is preferably 1 hour or more and 24 hours or less, and more preferably 20 hours or less.

The proportion out of 100 mol % of the unstable group in the second fluororesin which is converted to a carboxylic acid fluoride group is preferably 70 mol % or more, and particularly preferably 90 mol % or more.

As the alcohol having 1 to 3 carbon atoms to be reacted with the carboxylic acid fluoride group in the third fluororesin, one corresponding to the desired ester group is used. For example, when the ester group is a methoxycarbonyl group, methanol is used.

Examples of a method of converting a carboxylic acid fluoride group into an ester group include a method in which the third fluororesin is immersed in the above alcohol and heated at a temperature equal to or higher than the boiling point of the alcohol. The heating temperature at this time is preferably 65° C. or higher, more preferably 70° C. or higher, and preferably does not exceed the boiling point of the above alcohol by more than 40° C. The heating time is preferably 5 hours or more, and more preferably 10 hours or more, and preferably 48 hours or less, and more preferably 24 hours.

The proportion out of 100 mol % of the carboxylic acid fluoride group in the third fluororesin which is converted to an ester group is preferably 70 mol % or more, more preferably 90 mol % or more, and particularly preferably 99 mol % or more.

The first solvent may be any solvent as long as it can dissolve the first fluororesin, and examples thereof include solvents similar to those in a composition described later.

One type of the first solvent may be used alone, or two or more types thereof may be used in combination.

The first solution is obtained by mixing the first fluororesin and the first solvent. The content of the first fluororesin in the first solution is, for example, from 1 to 20% by mass with respect to the total mass of the first solution.

### <Second Solution>

The amino group in the amino group-containing compound is typically a primary amino group or a secondary amino group, and a primary amino group is preferred. The details and preferred embodiments of the coupling group are as explained in the section (Fluororesin) described above.

As the amino group-containing compound, a compound having an amino group and a silane coupling group (hereinafter also referred to as an “aminosilane compound”) is preferred from the viewpoint of further improving reactivity and adhesion to the base material of the obtained fluororesin.

Examples of the aminosilane compound include γ-aminopropylmethyldiethoxysilane, γ-aminopropylmethyldimethoxysilane, N-(β-aminoethyl)-γ-aminopropylmethyldimethoxysilane, N-(β-aminoethyl)-γ-aminopropylmethyldiethoxysilane, γ-aminopropyltrimethoxysilane, γ-aminopropyltriethoxysilane, N-(β-aminoethyl)-γ-aminopropyltrimethoxysilane, N-(β-aminoethyl)-γ-aminopropyltriethoxysilane, aminophenyltrimethoxysilane, aminophenyltriethoxysilane, aminophenyltripropoxysilane, aminophenyltriisopropoxysilane, aminophenylmethyldimethoxysilane, aminophenylmethyldiethoxysilane, aminophenylmethyldipropoxysilane, aminophenylmethyldiisopropoxysilane, aminophenylphenyldimethoxysilane, aminophenylphenyldiethoxysilane, aminophenylphenyldipropoxysilane, and aminophenylphenyldiisopropoxysilane. Among these, γ-aminopropyltriethoxysilane and γ-aminopropyltrimethoxysilane are preferred.

As the amino group-containing compound, the following compound 4 is preferred. When the compound 4 is used as the amino group-containing compound, the group 3 is formed when the first fluororesin and the amino group-containing compound are reacted.

H₂N—R⁴—SiR¹R²R³ Formula 4

In the Formula 4, R¹, R², R³ and R⁴ are as defined for R¹, R², R³ and R⁴ in the Formula 3, respectively.

One type of the amino group-containing compound may be used alone, or two or more types thereof may be used in combination.

The second solvent may be any solvent as long as it can dissolve the amino group-containing compound and be compatible with the first solvent. The second solvent is typically different from the first solvent.

As the second solvent, a protic fluorine-containing solvent which is compatible with the first solvent is preferred.

Examples of the protic fluorine-containing solvent include those shown below.

Fluorine-containing alcohols such as trifluoroethanol, 2,2,3,3,3-pentafluoro-1-propanol, 2-(perfluorobutyl) ethanol, 2-(perfluorohexyl) ethanol, 2-(perfluorooctyl) ethanol, 2-(perfluorodecyl) ethanol, 2-(perfluoro-3-methylbutyl) ethanol, 2,2,3,3-tetrafluoro-1-propanol, 2,2,3,3,4,4,5,5-octafluoro-1-pentanol, 2,2,3,3,4,4,5,5,6,6,7,7-dodecafluoro-1-heptanol, 2,2,3,3,4,4,5,5,6,6,7,7,8,8-hexadecafluoro-1-nonanol, 1,1,1,3,3,3-hexafluoro-2-propanol, and 1,3,3,4,4,4-hexafluoro-2-butanol; fluorine-containing carboxylic acids such as trifluoroacetic acid, perfluoropropanoic acid, perfluorobutanoic acid, perfluoropentanoic acid, perfluorohexanoic acid, perfluoroheptanoic acid, perfluorooctanoic acid, perfluorononanoic acid, perfluorodecanoic acid, 1,1,2,2-tetrafluoropropanoic acid, 1,1,2,2,3,3,4,4-octafluoropentanoic acid, 1,1,2,2,3,3,4,4,5,5-dodecafluoroheptanoic acid, and 1,1,2,2,3,3,4,4,5,5,6,6-hexadecafluorononanoic acid; fluorine-containing sulfonic acids such as trifluoromethanesulfonic acid and heptadecafluorooctanesulfonic acid; 1,1,1,2,2,3,3,4,4,5,5,6,6-tridecafluorohexane, 1,1,1,2,2,3,3,4,4,5,5,6,6-tridecafluorooctane, 1,3-bis(trifluoromethyl)benzene, 1,1,1,1,2,3,4,5,5,5-decafluoropentane, 1,1,2,2,3,3,4-heptafluorocyclopentane, cis-1-chloro-3,3,3-trifluoropropene, 1,3-bis(trifluoromethyl)benzene, 1-chloro-2,3,3-trifluoro-1-propene, 1,1,1,3,3-pentafluorobutane, 1,1,1,3,3,4,4-heptafluorodiethyl ether, 1,1,2,2,3,3,4,4-octafluorobutylmethyl ether, and 1,1,2,2,3,3,4-heptafluorocyclopentane.

Among these, 1,1,1,3,3,4,4-heptafluorodiethyl ether, trifluoroethanol, 1,1,1,2,2,3,3,4,4,5,5,6,6-tridecafluorohexane, 1,1,1,1,2,3,4,5,5,5-decafluoropentane, and 1,3-bis(trifluoromethyl)benzene are preferred.

One type of the second solvent may be used alone, or two or more types thereof may be used in combination.

The second solution is obtained by mixing the amino group-containing compound and the second solvent.

The content of the amino group-containing compound in the second solution is, for example, from 0.1 to 5% by mass with respect to the total mass of the second solution.

The amount of the second solution to be mixed with the first solution is set depending on the conversion rate of the ester group to an amide group.

After mixing the first solution and the second solution, for example, by stirring for a predetermined period of time, the first fluororesin reacts with the amino group-containing compound, and the ester group is converted into an amide group. The reaction temperature at this time is preferably from 20 to 50° C., and more preferably from 25 to 40° C. The reaction time is preferably 2 hours or more, and more preferably 3 hours or more, and preferably 10 hours or less, and more preferably 8 hours or less.

By converting some of the ester groups in the first fluororesin into amide groups as described above, a reaction solution comprising the present fluororesin can be obtained.

The conversion rate of ester groups to amide groups is from 10 to 50% calculated as the value of A. More specifically, when the value of A before conversion to an amide group (first fluororesin) is taken as A0, a ratio with the value of A after conversion to an amide group (the present fluororesin), that is, a ratio represented by A/A0, is from 0.5 to 0.9.

When the conversion rate of ester groups to amide groups is 10% or more, that is, when A/A0 is 0.9 or less, the adhesion to a base material is excellent. When the conversion rate of ester groups to amide groups is 50% or less, that is, when A/A0 is 0.5 or more, gelation is unlikely to occur under the coexistence of a solvent, resulting in excellent storage stability. The conversion rate of ester groups to amide groups is preferably from 20 to 50% when calculated as the value of A, and preferably from 0.5 to 0.8 as the value of A/A0.

The ratio represented by B/A after conversion to an amide group (the present fluororesin) is preferably from 0.010 to 0.7. When B/A is 0.010 or more, the adhesion to the base material is excellent. When B/A is 0.7 or less, gelation is unlikely to occur under the coexistence of a solvent, resulting in excellent storage stability.

When the values of A and B after conversion to an amide group (the present fluororesin) are defined as A2 and B1, respectively, a ratio represented by B1/A2 is preferably from 0.010 to 0.7. When B1/A2 is 0.010 or more, the adhesion to the base material is excellent. When B1/A2 is 0.7 or less, gelation is unlikely to occur under the coexistence of a solvent, resulting in excellent storage stability.

After the first fluororesin and the amino group-containing compound are reacted, it is preferable to perform a treatment for removing the unreacted amino group-containing compound from the reaction solution. By performing this treatment, gelation and coloration of the reaction solution due to the remaining amino group-containing compound can be suppressed.

Examples of the treatment for removing the amino group-containing compound include an adsorption treatment using an ion exchange resin, and an extraction treatment using a solvent (for example, ethanol) or water which is a good solvent for the amino group-containing compound and a poor solvent for the present fluororesin. Examples of the ion exchange resin used in the adsorption treatment include Amberlyst™, an ion exchange resin for catalysts manufactured by Organo Corporation.

### (Composition)

A composition according to one embodiment of the present invention (hereinafter also referred to as “the present composition”) comprises the present fluororesin and a solvent.

The present composition may further contain other components other than the present fluororesin and the solvent, as necessary, within a range that does not impair the effects of the present invention.

Examples of the solvent include a protic solvent and an aprotic solvent. A “protic solvent” is a solvent that has proton donating properties. An “aprotic solvent” is a solvent that does not have proton donating properties.

The solvent is preferably a solvent that dissolves at least the present fluororesin.

Examples of the protic solvent include those shown below.

Protic fluorine-containing solvents including: fluorine-containing alcohols such as trifluoroethanol, 2,2,3,3,3-pentafluoro-1-propanol, 2-(perfluorobutyl) ethanol, 2-(perfluorohexyl) ethanol, 2-(perfluorooctyl) ethanol, 2-(perfluorodecyl) ethanol, 2-(perfluoro-3-methylbutyl) ethanol, 2,2,3,3-tetrafluoro-1-propanol, 2,2,3,3,4,4,5,5-octafluoro-1-pentanol, 2,2,3,3,4,4,5,5,6,6,7,7-dodecafluoro-1-heptanol, 2,2,3,3,4,4,5,5,6,6,7,7,8,8-hexadecafluoro-1-nonanol, 1,1,1,3,3,3-hexafluoro-2-propanol, and 1,3,3,4,4,4-hexafluoro-2-butanol; fluorine-containing carboxylic acids such as trifluoroacetic acid, perfluoropropanoic acid, perfluorobutanoic acid, perfluoropentanoic acid, perfluorohexanoic acid, perfluoroheptanoic acid, perfluorooctanoic acid, perfluorononanoic acid, perfluorodecanoic acid, 1,1,2,2-tetrafluoropropanoic acid, 1,1,2,2,3,3,4,4-octafluoropentanoic acid, 1,1,2,2,3,3,4,4,5,5-dodecafluoroheptanoic acid, and 1,1,2,2,3,3,4,4,5,5,6,6-hexadecafluorononanoic acid; and fluorine-containing sulfonic acids such as trifluoromethanesulfonic acid and heptadecafluorooctanesulfonic acid.

Examples of the aprotic solvent include those shown below.

Aprotic fluorine-containing solvents including polyfluoroaromatic compounds such as 1,4-bis(trifluoromethyl)benzene, polyfluorotrialkylamine compounds such as perfluorotributylamine, polyfluorocycloalkane compounds such as perfluorodecalin, polyfluorocyclic ether compounds such as perfluoro (2-butyltetrahydrofuran), perfluoropolyethers, polyfluoroalkane compounds, and hydrofluoroethers (HFE).

One type of these solvents may be used alone or two or more types thereof may be used in combination. Further, a wide variety of compounds other than these can be used as a solvent.

As the solvent, an aprotic fluorine-containing solvent is preferred since it is a good solvent for the present fluororesin.

The boiling point of the solvent is preferably from 65 to 220° C., and particularly preferably from 70 to 220° C., because the formation of a uniform coating film is facilitated when the present composition is applied.

The content of the present fluororesin in the present composition is preferably 10% by mass or more, more preferably 20% by mass or more, and may be 100% by mass, with respect to the total solid content of the present composition. When the content of the present fluororesin is equal to or more than the above lower limit value, the adhesion of the coating film to the base material is further improved. Further, when the present composition comprises a reaction solution obtained by the above-described production method, it is easy to control the reaction rate of the amidation reaction and to suppress gelation.

The solid content is the sum of all components excluding the solvent.

The content of the solvent is set in accordance with the solid content concentration of the present composition.

The solid content concentration of the present composition may be appropriately set depending on the coating method of the present composition, the thickness of the coating film to be formed, and the like, and is, for example, from 0.1 to 20% by mass with respect to the present composition as a whole.

The present composition can be obtained, for example, by mixing the present fluororesin, a solvent, and other components as necessary. The reaction solution comprising the present fluororesin obtained by the production method described above can be used as it is as the present composition. The present composition may be obtained by partially or entirely replacing the solvents (the first solvent and the second solvent) of this reaction solution, and adding other components as necessary.

### (Article)

An article according to one embodiment of the present invention (hereinafter also referred to as “the present article”) has a coating film of the present composition on a base material. The present article comprises a base material and a coating film of the present composition provided on the surface of the base material.

The thickness of the coating film of the present composition is preferably from 0.01 to 10 μm, and more preferably from 0.1 to 5 μm. When the thickness of the coating film is equal to or more than the above lower limit value, the water repellency is further improved. When the thickness of the coating film is equal to or less than the above upper limit value, the adhesion and film flatness are further improved.

There are no particular restrictions on the base material, and examples thereof include glass base materials; metal base materials of silicon, steel use stainless (SUS), aluminum, copper, alloys thereof, and the like; plastic base materials of polyimide, imide, and the like; and base materials composed of multiple layers obtained by laminating one or more metal films or films on the above-described base materials.

The shape of the base material is also not particularly limited, and examples thereof include various shapes such as sheet, chip, film, fiber, spherical, polygonal, and porous shapes. The base material may be a substrate patterned with wiring or the like, a chip, or a semiconductor device.

The present article can be obtained by coating the present composition onto a base material, followed by drying.

There are no particular restrictions on the coating method, and known wet coating methods, printing methods, and casting methods can be applied.

The drying is not limited as long as the solvent can be removed, and may be drying at room temperature or drying by heating. The drying temperature is preferably from 80 to 250° C., and more preferably from 100 to 200° C.

Examples of applications of the present article include protective coatings in the optical and electrical fields such as optical fibers, lenses, solar cells, optical disks, touch panels, hybrid ICs, liquid crystal cells, printed circuit boards, photosensitive drums, film capacitors, glass windows, and various films, medical, physical and chemical equipment such as syringes, pipettes, thermometers, beakers, petri dishes, graduated cylinders, and biochips, protective, weather resistant, and antifouling coatings for solder masks, solder resists, rubbers, and plastics, protective coatings for fibers and fabrics, antifouling coatings for sealants, sealing films for semiconductor components including integrated circuits such as ICs and LSIs and transistors, buffer coating films for semiconductor components, passivation films for semiconductor components, interlayer dielectric films for semiconductor components in multimodules and integrated circuits, anticorrosion paints, resin adhesion prevention agents, ink adhesion prevention agents, interlayer dielectric films for multilayer printed circuit boards, antifouling, antireflection, optical retardation, and water- and oil-repellent films of optical equipment and optical members.

Preferred embodiments of the present invention also include, but are not limited to, the following [E1] to [E11].
[E1] A fluororesin composed only of a polymer having a fluorine-containing aliphatic ring structure within a main chain, wherein
the polymer comprises at least one of an alkoxycarbonyl group having an alkoxy group of 1 to 3 carbon atoms and an amide group having a coupling group, and
a cast film composed of the fluororesin with a thickness of 200 μm satisfies the following Formula 1 in an infrared spectrum measured by a transmission method with a Fourier transform infrared spectrophotometer,

0.010≤B/A≤0.7 Formula 1

In the Formula 1, A indicates a local maximum value of an absorbance at a wave number of 1,780 to 1,800 cm⁻¹ due to absorption of the alkoxycarbonyl group, using a straight line connecting an absorbance at a wave number of 1,700 cm⁻¹ and an absorbance at a wave number of 1,925 cm⁻¹ as a baseline, and
B indicates an absorbance value at a wave number of 1,720 cm⁻¹ due to absorption of the amide group, using a straight line connecting an absorbance at a wave number of 1,647 cm⁻¹ and an absorbance at a wave number of 1,763 cm⁻¹ as a baseline.
[E2] The fluororesin according to [E1] above, which has a mass average molecular weight of 10,000 to 500,000.
[E3] The fluororesin according to [E1] or [E2] above, wherein the polymer comprises a unit having a fluorine-containing aliphatic ring structure constituting a main chain.
[E4] The fluororesin according to [E3] above, wherein the unit having a fluorine-containing aliphatic ring structure constituting a main chain is at least one selected from the group consisting of a unit formed by cyclopolymerization of a diene-based fluorine-containing monomer, and a unit based on a cyclic fluorine-containing monomer.
[E5] The fluororesin according to any one of [E1] to [E4] above, wherein the coupling group is represented by the following Formula 2.

—SiR¹R²R³ Formula 2

In the Formula 2, each of R¹, R² and R³ independently represents an alkoxy group having 1 to 3 carbon atoms or an alkyl group having 1 to 3 carbon atoms, and
at least one of R¹, R² and R³ is the alkoxy group.
[E6] The fluororesin according to any one of [E1] to [E5] above, wherein the amide group is represented by the following Formula 3.

—CONH—R⁴—SiR¹R²R³ Formula 3

In the Formula 3, each of R¹, R² and R³ independently represents an alkoxy group having 1 to 3 carbon atoms or an alkyl group having 1 to 3 carbon atoms,
at least one of R¹, R² and R³ is the alkoxy group, and
R⁴ is an alkylene group, a group having an imino group between carbon atoms of an alkylene group, or an arylene group.
[E7] The fluororesin according to any one of [E1] to [E6] above, wherein the alkoxycarbonyl group and the amide group are each present at an end of a main chain of the polymer.
[E8] A method for producing the fluororesin according to any one of [E1] to [E7] above,
the method comprising: preparing a first solution by dissolving, in a first solvent, a first fluororesin composed only of a first polymer having a fluorine-containing aliphatic ring structure within a main chain and in which the first polymer comprises the alkoxycarbonyl group;
preparing a second solution by dissolving a compound having a coupling group and an amino group in a second solvent that is compatible with the first solvent; and
mixing the first solution and the second solution and converting 10 to 50% of the alkoxycarbonyl group, calculated as a value of the A, into an amide group by a reaction with the compound.
[E9] The production method according to [8] above, wherein in a second fluororesin composed only of a second polymer having a fluorine-containing aliphatic ring structure within a main chain and in which the second polymer comprises an unstable group at an end of the main chain, 50 to 100 mol % of the unstable group is converted into a carboxylic acid fluoride group by heating in the presence of molecular oxygen to obtain a third fluororesin, and
the carboxylic acid fluoride group of the third fluororesin is converted into the alkoxycarbonyl group by a reaction with an alcohol having 1 to 3 carbon atoms to obtain the first fluororesin.
[E10] A composition containing the fluororesin according to any one of [E1] to [E7] above and a solvent.
[E11] An article having a coating film of the composition according to [E10] above on a base material.

### EXAMPLES

Hereinafter, the present invention will be described in more detail with reference to Examples, but the present invention is not limited to the description of the following Examples.

Examples 1, 2, and 6 are Comparative Examples, and Examples 3 to 5 and 7 to 11 are Examples of the present invention.

### (Measurement Method)

### <Mass Average Molecular Weight (Mw)>

The mass average molecular weight of the fluororesin was determined by GPC in terms of PMMA.

### ≤B/A>

2 g of the fluororesin solution obtained in each example described below was collected into a mold produced with a polytetrafluoroethylene (PTFE) sheet and heated at 180° C. for 1 hour to obtain a cast film having a thickness of 200 μm. Regarding this cast film, the IR spectrum (horizontal axis: wave number, vertical axis: absorbance) was measured by a transmission method using FT-IR, and A, B, and B/A values were determined by the procedure described above.

### <Conversion Rate of Ester Group to Amide Group>

The value of A before conversion to an amide group was obtained in advance as A0 in the same manner as the above method for calculating B/A. From the value of A obtained when calculating B/A as described above, a ratio of A/A0 was determined by the above procedure, and the conversion rate of ester groups to amide groups was determined from this ratio.

### <Adhesion>

The fluororesin solution obtained in each example was spin-coated onto a silicon wafer, and baked at 60° C. for 10 minutes and then at 180° C. for 30 minutes to obtain a coating film of the fluororesin. A peel test was performed on this coating film using a cross-cut method based on JIS K 5600 May 6, and the adhesion was evaluated using the following criteria based on the residual film rate after 10 tape peelings.
A (favorable): residual film rate is 50% or more.
B (poor): residual film rate is less than 50%.

### <Storage Stability>

For the fluororesin solutions obtained in each example, the viscosity at 25° C. immediately after production (initial stage) was measured using an E-type viscometer. Thereafter, the fluororesin solution was stored in a refrigerator at 5° C. for 3 months, and then the viscosity was measured in the same manner as described above. From the measurement results, storage stability was evaluated based on the following criteria.
A (favorable): the viscosity of the fluororesin solution after storage is 1.3 times or less than the initial value.
B (poor): the viscosity of the fluororesin solution after storage is more than 1.3 times the initial value.

### Synthesis Example 1

A fluororesin (perfluoro (3-butenyl vinyl ether) polymer) having an unstable terminal group due to methanol was obtained in accordance with Synthesis Example 1 (paragraph [0067]) in International Patent Publication No. 2014/156996. The mass average molecular weight of this fluororesin was 80,000. When this fluororesin was analyzed by NMR, the presence of terminals due to carboxylic acid could not be confirmed. Therefore, it was not possible to replace —COOH with —COOCH₃ as described in Example 1 (paragraph [0076]) in Japanese Unexamined Patent Application, First Publication No. JP. H04-226177.

### Example 1

A fluororesin in which the unstable terminal group was converted to a carboxylic acid fluoride group was obtained by subjecting the fluororesin obtained in Synthesis Example 1 to a heat treatment under the same conditions as in Example 1 (paragraph [0068]) in International Patent Publication No. 2014/156996. At this time, the “carboxylic acid fluoride group conversion rate”, which was a ratio of unstable terminal groups converted to carboxylic acid fluoride groups, was 99 mol % or more. Further, the mass average molecular weight of the obtained fluororesin was 80,000.

The obtained fluororesin was dissolved in perfluorotributylamine so that the fluororesin concentration was 7% by mass, and the obtained fluororesin solution was evaluated for adhesion and storage stability. In Example 1, since the values of A and B were both 0, the calculation of B/A was omitted. Similarly, the conversion rate of ester groups to amide groups was also omitted. The results are shown in Table 1.

### Examples 2 to 6

The fluororesin obtained in Example 1 was formed into a sheet by compression molding, and then pulverized using a pulverizer to obtain irregularly shaped pellets with a diameter of 1 to 5 mm. 100 g of the above pellets followed by 200 g of methanol were placed in a 1 L jar made of tetrafluoroethylene-perfluoro (alkyl vinyl ether) copolymer (PFA), and the jar was sealed so that the outside air did not enter and heated in an oven at 90° C. for 12 hours. Subsequently, the methanol was replaced with fresh methanol, and the resulting mixture was heated at 90° C. for 12 hours. Thereafter, the pellets were dried. When the absorbance of the pellets after drying was observed using an FT-IR microscope, it was confirmed that the absorption peak at 1,883 cm⁻¹ due to the carboxylic acid fluoride group disappeared, and a peak at 1,795 cm⁻¹ due to —COOCH₃ was generated. There was no peak at 1,720 cm⁻¹ due to the amide group.

Subsequently, 70 g of the dried pellets described above and 930 g of perfluorotributylamine were placed and dissolved in a 2 L flask to obtain a fluororesin solution with a fluororesin concentration of 7% by mass. For this solution, the value of A0 was obtained using the method for determining B/A described above, and was used to calculate the conversion rate of ester groups to amide groups, which will be described later. Separately, aminopropyltrimethoxysilane (hereinafter also referred to as “methoxyaminosilane”) was mixed with 100 g of 1,1,1,3,3,4,4-heptafluorodiethyl ether to obtain a methoxyaminosilane solution. The above methoxyaminosilane solution was added to the flask containing the fluororesin solution described above so that the amount of methoxyaminosilane added was as shown in Table 1, and heated and stirred at 35° C. for 6 hours to replace —COOCH₃ in the fluororesin with an amide group (—CONH(CH₂)₃Si(OCH₃)₃). Subsequently, 10 g of an ion exchange resin (Amberlyst™ 15DRY, manufactured by Organo Corporation) was added to the reaction solution, and the resulting mixture was stirred at 25° C. for 2 hours to remove excess methoxyaminosilane. After that, the ion exchange resin used was filtered through a wire mesh with an opening of 100 μm, and the filtrate was placed in a 2 L flask connected to a vacuum pump and a trap tube to distill off 1,1,1,3,3,4,4-heptafluorodiethyl ether. Subsequently, perfluorotributylamine was added to the above flask so that the final fluororesin concentration was 7% by mass, and the obtained fluororesin solution was evaluated for B/A, conversion rate of ester groups to amide groups, adhesion, and storage stability. The results are shown in Table 1.

In Table 1, the “feed molar ratio” of methoxyaminosilane indicates a molar ratio of methoxyaminosilane with respect to 1 mole of fluororesin (molecular weight: 80,000).

### Example 7 to 11

Fluororesin solutions were respectively obtained in the same manner as in Examples 2 to 6, with the exception that aminopropyltrimethoxysilane was changed to aminopropyltriethoxysilane (hereinafter also referred to as “ethoxysilane”). The obtained fluororesin solution was evaluated for B/A, conversion rate of ester groups to amide groups, adhesion, and storage stability. The results are shown in Table 1.

In Table 1, the “feed molar ratio” of ethoxyaminosilane indicates a molar ratio of ethoxyaminosilane with respect to 1 mole of fluororesin (molecular weight: 80,000).

TABLE 1

| | Example | Example | Example | Example | Example | Example |
|---|---|---|---|---|---|---|
| | 1 | 2 | 3 | 4 | 5 | 6 |
| Methoxyaminosilane | — | 0.4 | 0.8 | 2.4 | 4 | 8 |
| feed molar ratio | | | | | | |
| Ethoxyaminosilane | — | — | — | — | — | — |
| feed molar ratio | | | | | | |
| Amount of | — | 0.07 | 0.14 | 0.43 | 0.72 | 1.4 |
| methoxyaminosilane | | | | | | |
| added (g) | | | | | | |
| Amount of | — | — | — | — | — | — |
| ethoxyaminosilane | | | | | | |
| added (g) | | | | | | |
| B/A | — | 0.0067 | 0.0690 | 0.2273 | 0.5000 | 0.8333 |
| Adhesion | B | B | A | A | A | A |
| [Residual film rate (%)] | [0] | [20] | [100] | [100] | [100] | [100] |
| Storage stability | A | A | A | A | A | B |
| [Viscosity rate] | [1.0] | [1.0] | [1.0] | [1.1] | [1.2] | [10] |
| Conversion rate of ester | — | 8 | 14 | 31 | 47 | 62 |
| group to amide group [%] | | | | | | |

| | Example | Example | Example | Example | Example |
|---|---|---|---|---|---|
| | 7 | 8 | 9 | 10 | 11 |
| Methoxyaminosilane | — | — | — | — | — |
| feed molar ratio | | | | | |
| Ethoxyaminosilane | 0.42 | 0.8 | 1.2 | 1.6 | 2.6 |
| feed molar ratio | | | | | |
| Amount of | — | — | — | — | — |
| methoxyaminosilane | | | | | |
| added (g) | | | | | |
| Amount of | 0.08 | 0.16 | 0.24 | 0.31 | 0.51 |
| ethoxyaminosilane | | | | | |
| added (g) | | | | | |
| B/A | 0.0130 | 0.0820 | 0.1893 | 0.2926 | 0.6021 |
| Adhesion | A | A | A | A | A |
| [Residual film rate (%)] | [60] | [100] | [100] | [100] | [100] |
| Storage stability | A | A | A | A | A |
| [Viscosity rate] | [1.0] | [1.0] | [1.1] | [1.1] | [1.2] |
| Conversion rate of ester | 13 | 22 | 29 | 35 | 49 |
| group to amide group [%] | | | | | |

The fluororesin solutions in Examples 3 to 5 and 7 to 11 exhibited excellent storage stability. Further, the coating film exhibited excellent adhesion. On the other hand, the coating films of the fluororesin solutions in Examples 1 and 2 in which B/A was less than 0.010 exhibited poor adhesion. The fluororesin solution in Example 7 with B/A exceeding 0.7 exhibited poor storage stability.

Although several embodiments and examples have been described above, these are presented as representative examples and do not limit the scope of the present invention.

Each embodiment and each example described in the present specification can be variously modified within the scope where the effects of the invention are exhibited, and can be combined with other features explained by other embodiments within the implementable scope.

### INDUSTRIAL APPLICABILITY

The fluororesin of the present invention is excellent in storage stability under the coexistence of a solvent and adhesion to a base material.

According to the method for producing a fluororesin of the present invention, a fluororesin excellent in storage stability under the coexistence of a solvent and adhesion to a base material can be obtained.

The composition of the present invention is excellent in storage stability and can form a coating film that exhibits excellent adhesion to a base material.

The article of the present invention exhibits excellent adhesion between a base material and a coating film. The article of the present invention can be used, for example, for protective coatings in the optical and electrical fields such as optical fibers, lenses, solar cells, optical disks, touch panels, hybrid ICs, liquid crystal cells, printed circuit boards, photosensitive drums, film capacitors, glass windows, and various films, medical, physical and chemical equipment such as syringes, pipettes, thermometers, beakers, petri dishes, graduated cylinders, and biochips, protective, weather resistant, and antifouling coatings for solder masks, solder resists, rubbers, and plastics, protective coatings for fibers and fabrics, antifouling coatings for sealants, sealing films for semiconductor components including integrated circuits such as ICs and LSIs and transistors, buffer coating films for semiconductor components, passivation films for semiconductor components, interlayer dielectric films for semiconductor components in multimodules and integrated circuits, anticorrosion paints, resin adhesion prevention agents, ink adhesion prevention agents, interlayer dielectric films for multilayer printed circuit boards, antifouling, antireflection, optical retardation, and water- and oil-repellent films of optical equipment and optical members.

1. A fluororesin composed only of a polymer having a fluorine-containing aliphatic ring structure within a main chain,
wherein the polymer comprises at least one of an alkoxycarbonyl group having an alkoxy group of 1 to 3 carbon atoms and an amide group having a coupling group, and
a cast film comprising the fluororesin with a thickness of 200 μm satisfies the following Formula 1 in an infrared spectrum measured by a transmission method with a Fourier transform infrared spectrophotometer,
0.010≤B/A≤0.7 Formula 1
wherein A indicates a local maximum value of an absorbance at a wave number of 1,780 to 1,800 cm⁻¹ due to absorption of the alkoxycarbonyl group, using a straight line connecting an absorbance at a wave number of 1,700 cm⁻¹ and an absorbance at a wave number of 1,925 cm⁻¹ as a baseline, and
B indicates an absorbance value at a wave number of 1,720 cm⁻¹ due to absorption of the amide group, using a straight line connecting an absorbance at a wave number of 1,647 cm⁻¹ and an absorbance at a wave number of 1,763 cm⁻¹ as a baseline.

2. The fluororesin according to claim 1, which has a mass average molecular weight of 10,000 to 500,000.

3. The fluororesin according to claim 1, wherein the polymer comprises a unit having a fluorine-containing aliphatic ring structure constituting a main chain.

4. The fluororesin according to claim 3, wherein the unit having a fluorine-containing aliphatic ring structure constituting a main chain is at least one selected from the group consisting of a unit formed by cyclopolymerization of a diene-based fluorine-containing monomer, and a unit based on a cyclic fluorine-containing monomer.

5. The fluororesin according to claim 1, wherein
the coupling group is represented by the following Formula 2:
—SiR¹R²R³ Formula 2
wherein each of R¹, R² and R³ independently represents an alkoxy group having 1 to 3 carbon atoms or an alkyl group having 1 to 3 carbon atoms, and
at least one of R¹, R² and R³ is the alkoxy group.

6. The fluororesin according to claim 1, wherein the amide group is represented by the following Formula 3:
—CONH—R⁴—SiR¹R²R³ Formula 3
wherein each of R¹, R² and R³ independently represents an alkoxy group having 1 to 3 carbon atoms or an alkyl group having 1 to 3 carbon atoms,
at least one of R¹, R² and R³ is the alkoxy group, and
R⁴ is an alkylene group, a group having an imino group between carbon atoms of an alkylene group, or an arylene group.

7. The fluororesin according to claim 1, wherein the alkoxycarbonyl group and the amide group are each present at an end of a main chain of the polymer.

8. A method for producing the fluororesin according to claim 1, the method comprising:
preparing a first solution by dissolving, in a first solvent, a first fluororesin composed only of a first polymer having a fluorine-containing aliphatic ring structure within a main chain and in which the first polymer comprises the alkoxycarbonyl group;
preparing a second solution by dissolving a compound having a coupling group and an amino group in a second solvent that is compatible with the first solvent; and
mixing the first solution and the second solution and converting 10 to 50% of the alkoxycarbonyl group, calculated as a value of the A, into an amide group by a reaction with the compound.

9. The production method according to claim 8, wherein in a second fluororesin composed only of a second polymer having a fluorine-containing aliphatic ring structure within a main chain and in which the second polymer comprises an unstable group at an end of the main chain,
50 to 100 mol % of the unstable group is converted into a carboxylic acid fluoride group by heating in the presence of molecular oxygen to obtain a third fluororesin, and
the carboxylic acid fluoride group of the third fluororesin is converted into the alkoxycarbonyl group by a reaction with an alcohol having 1 to 3 carbon atoms to obtain the first fluororesin.

10. A composition comprising the fluororesin according to claim 1 and a solvent.

11. An article comprising a coating film of the composition according to claim 10 on a base material.
